(19) United States
(12) Patent Application Publication
(10) Pub. No.: US 2026/0140741 A1
(43) Pub. Date: May 21, 2026

(54) NESTED CONTAINER GENERATION FOR CROSS-PLATFORM WORKLOADS

(71) Applicant: Red Hat, Inc., Raleigh, NC (US)

(72) Inventor: Giuseppe Scrivano, Rome (IT)

(21) Appl. No.: 18/954,275

(22) Filed: Nov. 20, 2024

(51) Int. Cl. G06F 9/4401

(52) U.S. Cl. CPC G06F 9/4401

(57) ABSTRACT

A system can be provided for generating a nested container for a cross-platform workload. For example, the system can receive, by an initialization service of a first container, a request associated with a cross-platform workload. The system can further generate, by the initialization service, a second container based on the request. The second container may execute within the first container and the second container may use a network namespace of the first container. The system may then execute, by the initialization service, the cross-platform workload in the second container.

### TECHNICAL FIELD

The present disclosure relates generally to containers. More specifically, but not by way of limitation, this disclosure relates to generating a nested container for a cross-platform workload.

### BACKGROUND

Software services such as applications, serverless functions, and microservices can be deployed inside containers within a computing environment. Deploying the software services inside the containers can help isolate the software services from one another, which can improve speed and security and provide other benefits. Containers can be deployed by a container scheduler or orchestration technology from image files using a container engine. An example of an orchestration technology is Kubernetes®.

Image files are often referred to as container images. A container image can be conceptualized as a stacked arrangement of layers in which a base layer is positioned at the bottom and other layers are positioned above the base layer. The base layer may include operating system files for deploying a guest operating system inside the container. The guest operating system may be different from the underlying host operating system of the physical machine on which the container is deployed. Storage drivers can manage contents of the container images. The storage drivers can further enable creation of data in a writable layer of a container (e.g., container layer) and can manage interactions between image layers and the container layer. Additionally, a runtime can be a software component that can create and run containers. In a containerized architecture, the runtime can load the container images from a repository, monitor host operating system resources, and manage container lifecycle.

### BRIEF DESCRIPTION OF THE DRAWINGS

FIG. 1 is a block diagram of an example of a computing environment for generating a nested container for a cross-platform workload according to some aspects of the present disclosure.

FIG. 2 is a block diagram of another example of a computing environment for generating a nested container for a cross-platform workload according to some aspects of the present disclosure.

FIG. 3 is a flow chart of an example of a method for generating a nested container for a cross-platform workload according to some aspects of the present disclosure.

### DETAILED DESCRIPTION

Setting up an environment for running a container can be an expensive operation. For example, setting up a Podman or Docker container that adheres to the Open Container Initiative, has its own network and storage, and has default configuration settings can take up to 200 milliseconds (ms). In some instances, the time associated with setting up containers can be a prohibitive cost. In one example, a container may be set up and used to execute a serverless function. However, the time used for setting up the container may delay execution of and hinder scalability of the serverless function. Additionally, the serverless function may have an execution time limit. Thus, the time used for container set up can reduce the time available for processing tasks associated with the serverless function. Moreover, the serverless function may be idle while the container is set up, thereby wasting computing resources (e.g., CPU, power, memory, storage, etc.). In another example, a container may be used to execute a WebAssembly (WASM) workload. However, WASM workloads are designed for high performance and low latency. Thus, the time for container set up may negate these benefits, causing latency at the computing application associated with the WASM workload. The lengthy container set up time can further result in unnecessary resource consumption, which increases operational costs of the WASM workload and decreases scalability. Accordingly, container set up time can degrade performance in computing applications (e.g., by causing latency) and waste computing resources. These drawbacks can be especially impactful in situations in which high performance and fast execution times are of great importance (e.g., WASM workloads, serverless functions, or the like).

Some examples of the present disclosure can overcome one or more of the abovementioned problems by an initialization service that can generate a custom, nested container for a cross-platform workload. The initialization service may run in an outer container. The initialization service may receive a request to execute a cross-platform workload (e.g., a WASM workload, a serverless function, or the like). In response to receiving the request, the initialization service may set up a lightweight, nested container within the outer container in which the cross-platform workload may be deployed and executed. Due to the initialization service setting up the inner container within the outer container, the inner container can reuse an environment of the outer container. For example, inner container can reuse a network space of the outer container. Other features of the environment of the outer container may be added to or customized for the cross-platform workload. For example, the initialization service may create a new user namespace, a temporary file system, a new sub-control group, or perform other tasks with respect to the outer container to create the inner container for the cross-platform workload. By reusing, adding to, adjusting, or a combination thereof the environment of the outer container, the set up of the inner container can be faster than, for example, the container that adheres to the Open Container Initiative and that has its own network and storage with default configuration settings. For example, the inner container may be set up and ready to execute the cross-platform workload in 3 to 6 ms, 6 to 50 ms, or 1 to 100 ms. Accordingly, the initialization service can facilitate execution of the cross-platform workload in a fast and computing resource efficient manner. Moreover, the isolated nature of the inner container enables the cross-platform workload to be performed in a secure manner.

In a particular example, the initialization service can be executing in a first container on a host device. The initialization service may receive a request associated with a cross-platform workload. For example, there may be a serverless function that resizes and stores images. A user may upload an image to an S3 bucket. In response, a request to execute the serverless function can be transmitted to the host device, which may be a virtual environment (e.g., a virtual machine). The initialization service can receive the request and, in response, can generate a second container based on the request.

To generate the second container, the initialization service may adjust some aspects of the environment associated with the first container. In this way, the initialization service can generate a secure, isolated environment (i.e., the second container) for executing the serverless function in an expedited manner (e.g., faster than generating the second container from scratch). For example, the initialization service can use a network namespace of the first container for the second container. The initialization service can further create a new user namespace, a temporary filesystem, a new sub-control group, a PID namespace, or a combination thereof. The initialization service may further copy a payload associated with the serverless function into the temporary file system, fork itself and move into the new sub-control group, make the temporary filesystem the root for the second container, or a combination thereof. The initialization service may also set standard streams based on file descriptors received via the request. Additionally, the initialization service may mount file systems such as “/proc”, “/sys”, “/sys/fs/cgroup”, other file systems used for running the second container, or a combination thereof.

Once the second container is generated, the initialization service can execute the serverless function in the second container. In this way, the serverless function can be executed in the secure, isolated environment and without performance degradation, latency, excess computing resource usage, or other undesirable effects of the time associated with setting up a new, freestanding (e.g., non-nested container).

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

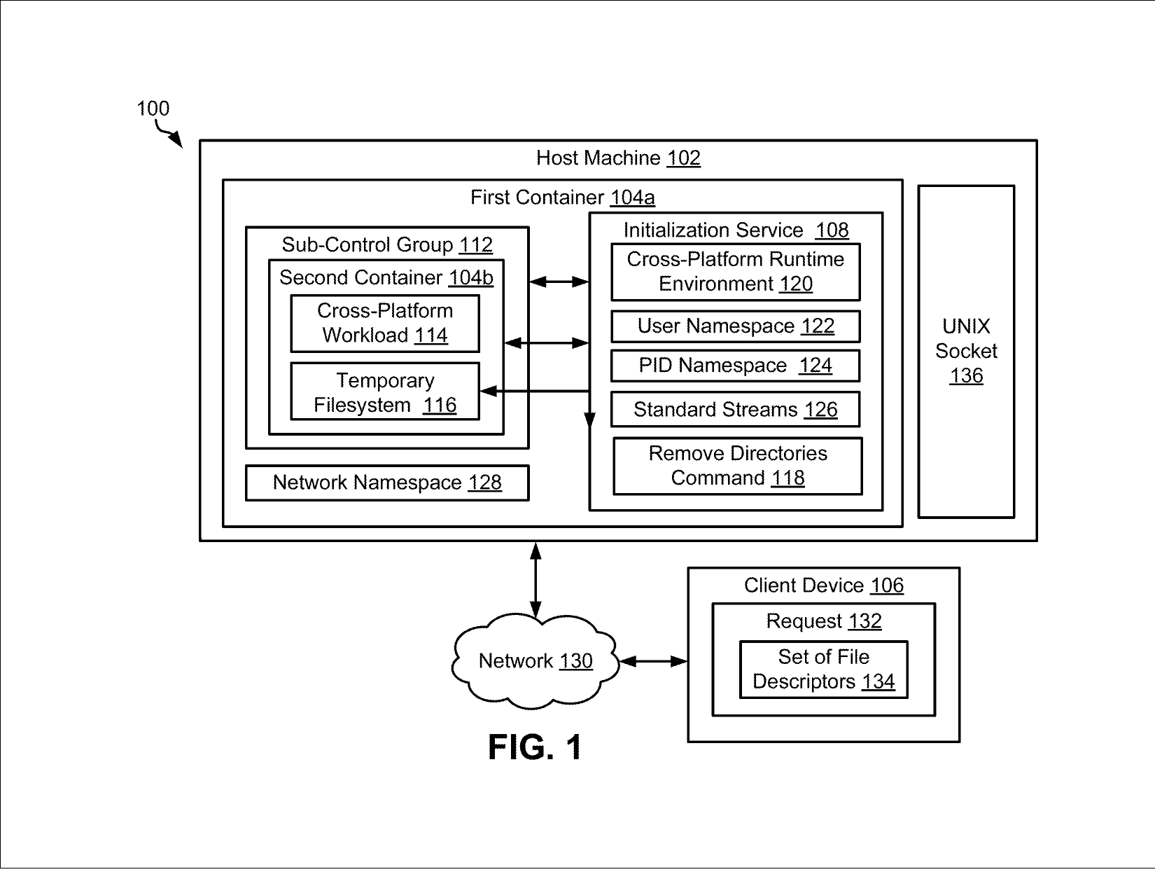

FIG. 1 is a block diagram of an example of a computing environment 100 for generating a nested container for a cross-platform workload according to some aspects of the present disclosure. Components within the computing environment 100 may communicate using a network 130, such as the Internet or other suitable wide area network. The components of the computing environment 100 can include a host machine 102 and a client device 106. The computing environment 100 can be any type of computing environment such as, but not limited to, an edge computing environment, a distributed computing environment, a cloud computing environment, a personal computing environment, or the like. Examples of the the client device 106 can include servers, routers, controllers, microcontrollers, smart devices, sensors, smartphones, tablets, wearable devices, vehicles, Internet of Things (IoT) devices, etc. Additional examples of the client device 106 can include non-physical devices, such as virtual machines or containers.

The host machine 102 can be a physical or virtual server or other computing device that provides underlying infrastructure and computing resources (e.g., CPU, memory, storage, networking capabilities, etc.) for running various software applications, software services, runtime environments, or the like. The host machine 102 can further run a container runtime (e.g., Docker, containerd, CRI-O, runc, or the like), thereby enabling the execution of workloads (e.g., cross-platform workloads) on the host machine 102 in isolated environments (e.g., containers).

In some examples, a first container 104a can be deployed on the host machine 102 and can include an initialization service 108. The initialization service 108 can be a software service that can prepare (e.g., generate and deploy) a container (e.g., a second container 104b) for a cross-platform workload 114. As a result, the container prepared by the initialization service 108 may be a nested container deployed with the first container 104a that can provide an isolated and secure environment for executing the cross-platform workload 115.

A cross-platform workload can involve one or more tasks designed to be operable on more than one operating system or platform without modification. Examples cross-platform workloads can include web applications, mobile applications, Java applications, game engines, or the like. Web Assembly (WASM) workloads are another example of cross-platform workloads, which may involve one or more tasks executed using WASM. In some examples, the initialization service 108 can include a cross-platform runtime environment 120, which can be a software layer that facilitates execution of a cross-platform workload. For example, if the cross-platform workload 114 is a WASM workload, the cross-platform runtime environment 120 of the initialization service 108 may be a WASM virtual machine (VM) configured to execute WASM code associated with the WASM workload.

The initialization service 108 may generate the second container 104b for the cross-platform workload 114 in response to receiving a request 132 associated with the cross-platform workload 114. For example, the initialization service 108 may expose an inter-process communication mechanism (e.g., UNIX socket 136) that is reachable from the host machine 102. The initialization service 108 may then receive the request via the inter-process communication mechanism, such as the UNIX socket 136. In other examples, the initialization service 108 may receive the request 132 via other communication protocols, such as HTTP.

The request 132 may include binary data, code, or a reference (e.g., a URL or file path) pointing to the binary data or code. For example, the request may include a module (e.g., a compiled code package) or a reference to a module. The request 132 may further include a particular function being called or otherwise specify the particular task that is to be executed. In a particular example in which the cross-platform workload is a WASM workload, the request 132 can include a WASM module or a reference to the WASM module. In the particular example, the request 132 can further include the function within the WASM module that is to be executed. The request 132 may also include parameters or input arguments for the function, metadata or configuration settings for the execution environment (e.g., memory limits, timeouts, or the like), information indicating how a response to the request should be formatted, security tokens or other information usable to validate the request, or other suitable information. Consequently, the initialization service 108 may receive any combination of the above information via the request 132.

Additionally, via the request 132, the initialization service 108 can receive a set of file descriptors 134. The set of file descriptors 134 may be abstract indicators usable to access a file or a I/O resource such as sockets or devices. The set of file descriptors 134 may include one or more WASM payload file descriptors and one or more standard streams file descriptors. Other file descriptors for other files or resources may also be included in the set of file descriptors 134. The WASM payload file descriptors can be file descriptors that facilitate interactions between a WASM module and files or I/O resources. The standard streams file descriptors can be file descriptors for basic input and output operations. The standard streams file descriptors can include standard input, standard output, and standard error.

To generate the second container 104b, the initialization service 108 may set standard streams 126 based on the standard streams file descriptors. The initialization service 108 may also generate a user namespace 122. The user namespace 122 can enable the cross-platform workload 114 to operate with a unique user identification without affecting the host machine 102 or other user namespaces (e.g., a user namespace of the first container 104a). Due to the unique user identification, the cross-platform workload 114 can have root privileges in the second container 104b, but may not have root privileges outside of the second container 104b. Thus, by generating a user namespace 122, the initialization service 108 can isolate the cross-platform workload 114, thereby enabling secure execution of the cross-platform workload 114 on the host machine 102.

Additionally, in some examples, the initialization service 108 may generate a Process identifier (PID) namespace 124. The PID namespace 124 can enable processes (e.g., the cross-platform workload 114) in the second container 104b to be isolated from processes outside of the second container 104b. In examples in which the PID namespace 124 is generated, the cross-platform workload 114 can be the first process in the PID namespace 124. As such, when the cross-platform workload 114 terminates (e.g., when the cross-platform workload 113 is completed), the second container 104b associated with the PID namespace 124 can be terminated as well. The initialization service may also generate Unix timesharing system (UTS) namespaces, inter-process communication (IPC) namespaces, mount namespaces, control group namespaces, other suitable namespaces, or a combination thereof for the second container 104b. Moreover, the initialization service 108 may mount file systems such as “/proc”, “/sys”, “/sys/fs/cgroup”, other file systems used for running the second container 104b, or a combination thereof.

Additionally, to generate the second container 104b, the initialization service 108 may generate a temporary file system 116 (e.g., tmpfs). The initialization service 108 may further copy code, data, or the combination thereof associated with the cross-platform workload 114 into the temporary file system 116. The code, data, or the combination thereof may be included in the request 132. By generating the temporary file system 116 and copying the code, data, or the combination thereof associated with the cross-platform workload 114 into the temporary file system 116, the data, code, or the combination thereof can be isolated from the host machine 102, the first container 104a, or the combination thereof, thereby enhancing security for the cross-platform workload 114. The initialization service 108 can also make the temporary file system 116 a root file system for the second container 104b.

The initialization service 108 may further generate a sub-control group 112 for the second container 104b. The sub-control group 112 can be a child or nested group within a control group associated with the first container 104a. The sub-control group 112 can inherit computing resource limits and allocation policies from the control group associated with the first container 104a while further including more refined computing resource limits, computing resourced allocation policies, or a combination thereof for the second container 104b. For example, in generating the sub-control group 112 for the second container 104b, the initialization service 108 can assign the cross-platform workload 114 to the sub-control group 112 and can assign computing resource limitations (e.g., a CPU or memory limit) to the sub-control group 112. As a result, the computing resource limitations can be imposed on the cross-platform workload 114 to ensure efficient computing resource usage at the host machine 102. Moreover, the initialization service 108 may fork to generate a copy of itself for the sub-control group 112. In this way, the initialization service 108 can perform further operations with respect to the cross-platform workload 114 (e.g., executing the cross-platform workload 114) from with the isolated environment of the sub-control group 112 generated for the second container 104b.

Once the second container 104b is generated (e.g., once any namespaces, files, control groups, or the like are obtained, generated, or otherwise prepared), the initialization service 108 may execute the cross-platform workload 114 using the second container 104b. As mentioned above the second container 104b can be a nested container running within the first container 104a. As such, the second container can reuse some features of an environment of the first container 104a, such as a network namespace 128 of first container. Because the initialization service 108 can reuse some features of the environment of the first container 104a, the second container 104b can be set up in an efficient manner thereby enabling efficient execution of the cross-platform workload in the second container 104b.

Additionally, the initialization service 108 can limit execution of cross-platform workloads in the network namespace 128 to one at a time. Therefore, when the payload terminates (e.g., when the code associated with the cross-platform workload 114 has finished executing), namespaces (e.g., the user namespace 122 and the PID namespace 124) are automatically cleaned up by a kernel of the host machine 102. The initialization service 108 may then remove directories by executing a remove directories command 118. Once the namespaces are cleaned up and the initialization service 102 has executed the remove directories command 118, the initialization service 102 may receive another request associated with another cross-platform workload from the client device 106 or another client device and may generate a new nested container for the cross-platform workload.

In some examples, the initialization service 108 may also report statistics from the sub-control group 112 after the payload terminates. Such statistics can include CPU usage, memory usage, I/O bandwidth, network bandwidth, or other computing resource metrics associated with the cross-platform workload 114.

The example shown in FIG. 1 is illustrative, but various modifications are possible. For example, while FIG. 1 depicts a specific arrangement of components, other examples can include more components, fewer components, different components, or a different arrangement of the components shown in FIG. 1. Additionally, any component or combination of components depicted in FIG. 1 can be used to implement the process(es) described herein. Further, while certain components are depicted in FIG. 1 as being internal or external to the host machine 102, other examples can involve other configurations of the components.

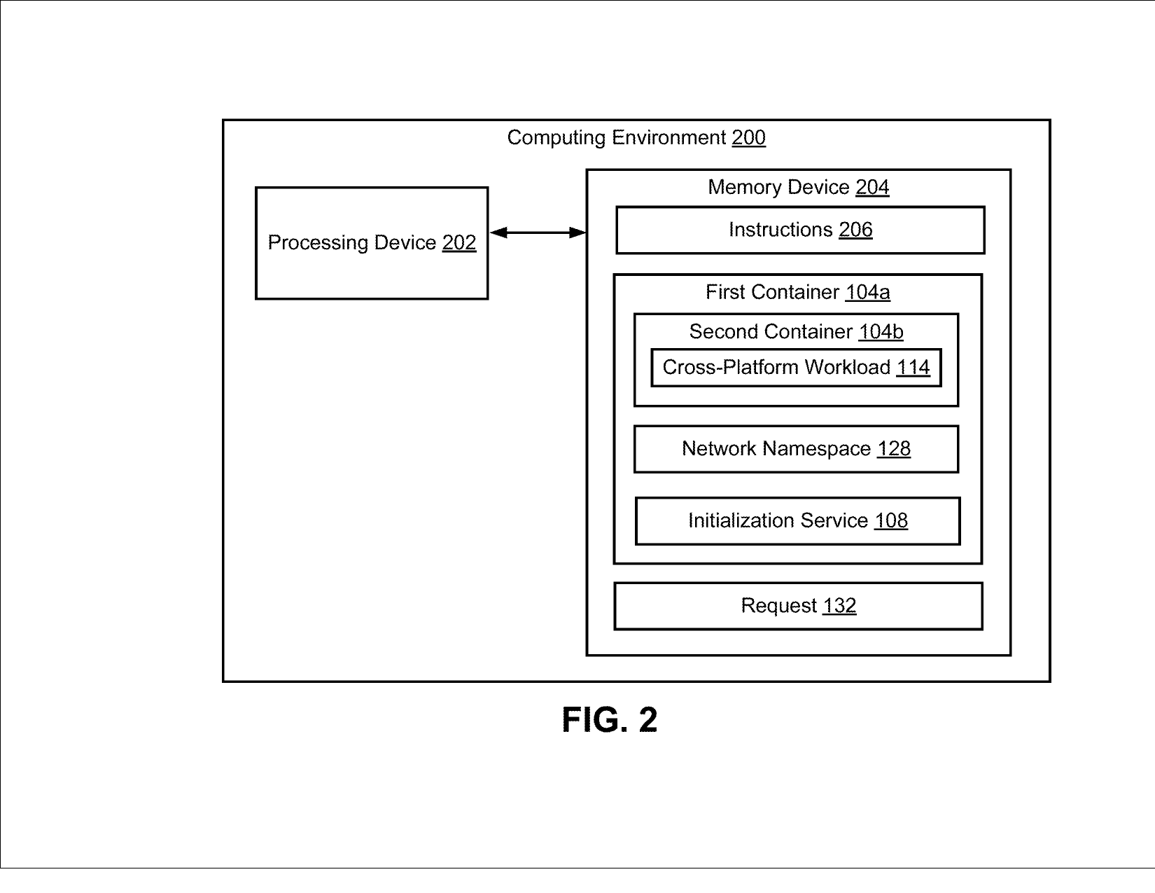

FIG. 2 is a block diagram of another example of a computing environment 200 for generating a nested container for a cross-platform workload according to some aspects of the present disclosure. The computing environment 200 can include a processing device 202 communicatively coupled to a memory device 204. In some examples, the processing device 202 and the memory device 204 can be housed in a single device. In other examples, the processing device 202 and the memory device 204 can be distributed from one another.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C#, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code. Non-limiting examples of a computer-readable medium include magnetic disk(s), memory chip(s), ROM, random-access memory (RAM), an ASIC, a configured processor, and optical storage.

In some examples, the memory device 204 can store instructions 206 that can be executable by the processing device 202 to perform operations. For example, the processing device 202 may receive, via an initialization service 108 of a first container 104a, a request 132 associated with a cross-platform workload 114. The processing device 202 may then generate, via the initialization service 108, a second container 104b based on the request 132. The second container 104b may execute within the first container and the second container 104b may use a network namespace 128 of the first container 104a. The processing device 202 may further execute, via the initialization service 108, the cross-platform workload 114 in the second container 104b.

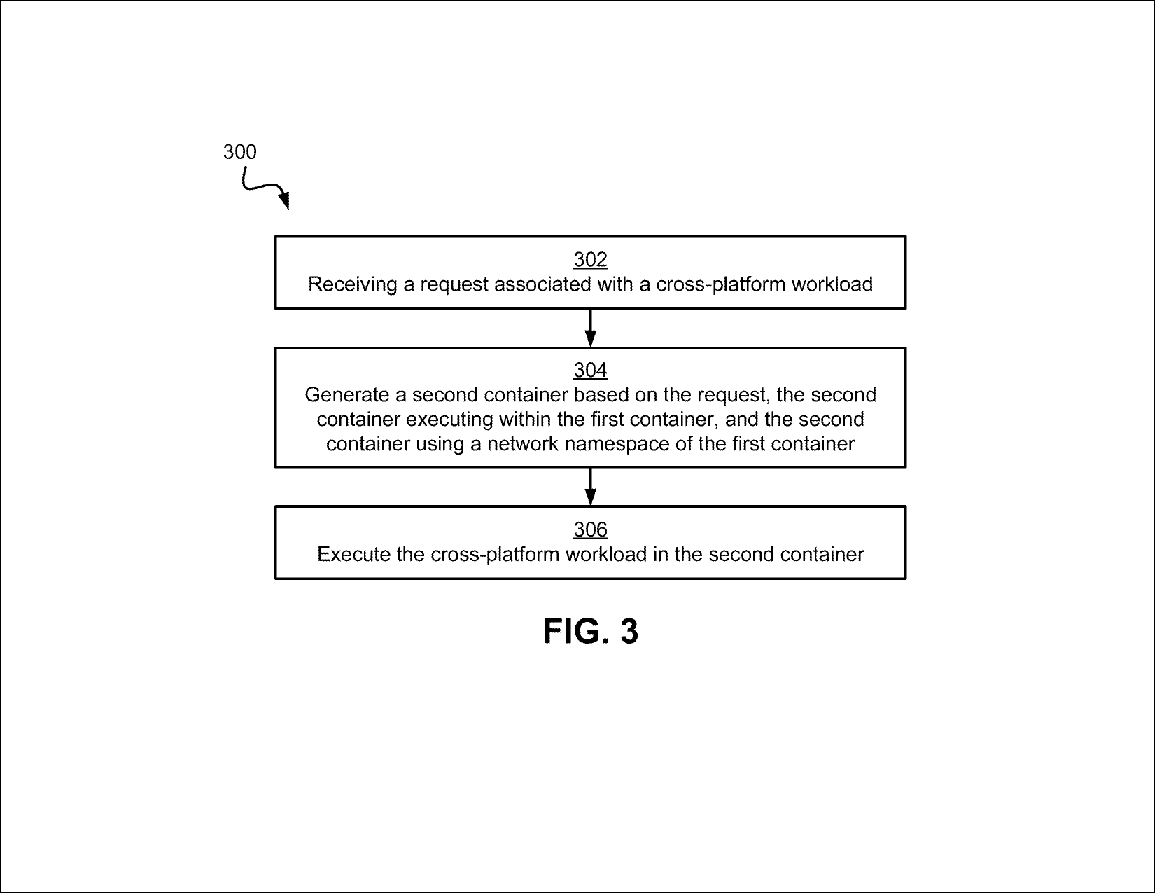

FIG. 3 is a flow chart of an example of a method 300 for generating a nested container for a cross-platform workload according to some aspects of the present disclosure. In one example, the processing device 202 can execute the initialization service 110 of FIG. 1 to perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

At block 302, the processing device 202 can receive, by an initialization service 108 of a first container 104a, a request 132 associated with a cross-platform workload 114. The processing device 202 may be part of or communicatively coupled with a host machine 102. The host machine 102 may be a server, desktop, or other computing device or environment usable to process cross-platform workloads in an efficient and secure manner. To facilitate the efficient and secure processing of cross-platform workloads, the processing device 202 can deploy and execute the first container 114a on the host machine 102. The processing device 202 can further execute the initialization service 108 in an environment of the first container 114a to receive and process the request 132. The request 132 received by the processing device 202 via the initialization service 108 can be a request to execute the cross-platform workload 114 (e.g., a WASM workload). In one example, the cross-platform workload 114 can involve a cryptographic operation (e.g., hashing, encryption, or decryption) and therefore the request 132 can be a request to perform the cryptographic operation.

At block 304, the processing device 202 can generate, by the initialization service 108, a second container 104b based on the request 132. The second container 104b may execute within the first container 104a and the second container 104b may use a network namespace 128 of the first container. To generate the second container 104b that executes within the first container 104a and uses the network namespace 128 of the first container, the processing device 202 can, by the initialization service 108, modify the environment of the second container 104b. For example, the processing device 202 can, by the initialization service 108, generate a new user namespace, a temporary filesystem, a new sub-control group, a PID namespace, or a combination thereof within the first container 108a. Additionally, the processing device 202 can, via the initialization service 108, copy a payload associated with the WASM workload into the temporary file system, fork itself and move into the new sub-control group, make the temporary filesystem the root for the second container, or a combination thereof. The processing device 202 may also, via the initialization service 108, set standard streams based on file descriptors received via the request 132. Moreover, the processing device 202 may, via the initialization service 108, mount file systems such as “/proc”, “/sys”, “/sys/fs/cgroup”, other file systems used for running the second container, or a combination thereof.

As a result of modifying the environment of the first container 104a to include a new user namespace, a temporary filesystem, a new sub-control group, a PID namespace, or a combination thereof as well as using preexisting aspects of the environment of the first container 104a (e.g., the network namespace), the processing device 202 can generate the second container 104b in an efficient manner and such that the second container 104b is tailored to the WASM workload associated with the request 132.

At block 306, the processing device 202 can execute, by the initialization service 108, the cross-platform workload 114 in the second container 104b. In the example, the cryptographic operation can be carried out in a secure, isolated environment (e.g., in the second container 104b) in an efficient manner (e.g., without performance degradation, latency, excess computing resource usage, or other undesirable effects of the time associated with setting up a new, freestanding container rather than a nested container).

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. The examples disclosed herein may be combined or rearranged to yield additional examples.

What is claimed is:

1. A system comprising:
a processing device; and
a memory device including instructions that are executable by the processing device for causing the processing device to perform operations comprising:
receiving, by an initialization service of a first container, a request associated with a cross-platform workload;
generating, by the initialization service, a second container based on the request, the second container executing within the first container, and the second container using a network namespace of the first container; and
executing, by the initialization service, the cross-platform workload in the second container.

2. The system of claim 1, wherein the operation of receiving, by the initialization service of the first container, the request associated with the cross-platform workload comprises receiving a set of file descriptors comprising at least a WASM payload file descriptor and a standard streams file descriptor.

3. The system of claim 2, wherein the operation of generating, by the initialization service, the second container based on the request comprises setting one or more standard streams based on the standard streams file descriptor.

4. The system of claim 1, wherein the operation of generating, by the initialization service, the second container based on the request comprises:
generating a user namespace, a process identifier namespace, and a temporary file system;
copying code or data associated with the cross-platform workload into the temporary file system; and
setting the temporary file system as a root for the second container.

5. The system of claim 4, wherein the operation of generating, by the initialization service, the second container based on the request comprises:
generating a sub-control group for the second container; and
forking to generate a copy of the initialization service for the sub-control group.

6. The system of claim 1, wherein the request is a first request and wherein the operations further comprise, subsequent to executing the cross-platform workload using the second container:
executing a remove directories command; and
subsequent to executing the remove directories command, receiving a second request associated with another cross-platform workload.

7. The system of claim 1, wherein the cross-platform workload is a Web Assembly workload and wherein the initialization service includes a Web Assembly virtual machine.

8. A computer-implemented method comprising:
receiving, by an initialization service of a first container, a request associated with a cross-platform workload;
generating, by the initialization service, a second container based on the request, the second container executing within the first container, and the second container using a network namespace of the first container; and
executing, by the initialization service, the cross-platform workload in the second container.

9. The computer-implemented method of claim 8, wherein receiving, by the initialization service of the first container, the request associated with the cross-platform workload comprises receiving a set of file descriptors comprising at least a WASM payload file descriptor and a standard streams file descriptor.

10. The computer-implemented method of claim 9, wherein generating, by the initialization service, the second container based on the request comprises setting one or more standard streams based on the standard streams file descriptor.

11. The computer-implemented method of claim 8, wherein generating, by the initialization service, the second container based on the request comprises:
generating a user namespace, a process identifier namespace, and a temporary file system;
copying code or data associated with the cross-platform workload into the temporary file system; and
setting the temporary file system as a root for the second container.

12. The computer-implemented method of claim 11, wherein generating, by the initialization service, the second container based on the request further comprises:
generating a sub-control group for the second container; and
forking to generate a copy of the initialization service for the sub-control group.

13. The computer-implemented method of claim 8, wherein the request is a first request and wherein the computer-implemented method further comprises, subsequent to executing the cross-platform workload using the second container:
executing a remove directories command; and
subsequent to executing the remove directories command, receiving a second request associated with another cross-platform workload.

14. The computer-implemented method of claim 8, wherein the cross-platform workload is a Web Assembly workload and wherein the initialization service includes a Web Assembly virtual machine.

15. A non-transitory computer-readable medium comprising instructions that are executable by a processing device for causing the processing device to perform operations comprising:
receiving, by an initialization service of a first container, a request associated with a cross-platform workload;
generating, by the initialization service, a second container based on the request, the second container executing within the first container, and the second container using a network namespace of the first container; and
executing, by the initialization service, the cross-platform workload in the second container.

16. The non-transitory computer-readable medium of claim 15, wherein the operation of receiving, by the initialization service of the first container, the request associated with the cross-platform workload comprises receiving a set of file descriptors comprising at least a WASM payload file descriptor and a standard streams file descriptor.

17. The non-transitory computer-readable medium of claim 16, wherein the operation of generating, by the initialization service, the second container based on the request comprises setting one or more standard streams based on the standard streams file descriptor.

18. The non-transitory computer-readable medium of claim 15, wherein the operation of generating, by the initialization service, the second container based on the request comprises:
generating a user namespace, a process identifier namespace, and a temporary file system;
copying code or data associated with the cross-platform workload into the temporary file system; and
setting the temporary file system as a root for the second container.

19. The non-transitory computer-readable medium of claim 18, wherein the operation of generating, by the initialization service, the second container based on the request comprises:
generating a sub-control group for the second container; and
forking to generate a copy of the initialization service for the sub-control group.

20. The non-transitory computer-readable medium of claim 15, wherein the request is a first request and wherein the operations further comprise, subsequent to executing the cross-platform workload using the second container:
executing a remove directories command; and
subsequent to executing the remove directories command, receiving a second request associated with another cross-platform workload.
